(19) United States
(12) Patent Application Publication
(10) Pub. No.: US 2020/0378366 A1
(43) Pub. Date: Dec. 3, 2020

(54) Estimating The Clearance Between A Tower And Foundations Of A Wind Turbine

(71) Applicant: Electricite de France, Paris (FR)

(72) Inventor: Pierre Stephan, Sartrouville (FR)

(73) Assignee: Electricite de France, Paris (FR)

(21) Appl. No.: 16/959,722

(22) PCT Filed: Jan. 7, 2019
(86) PCT No.: PCT/EP2019/050246

§ 371 Date: Jul. 2, 2020

(30) Foreign Application Priority Data
Jan. 8, 2018 (FR) 1850106

(51) Int. Cl. F03D 17/00; F03D 13/20

(52) U.S. Cl. CPC F03D 17/00; F03D 13/22; F05B 2260/80; F05B 2270/807; F05B 2250/40

(57) ABSTRACT

The invention relates to a method for estimating a clearance (7) between a tower (2) and foundations (6) of a wind turbine (1), comprising the following steps: S1: acquiring N maximum accelerations of the tower (2) of the wind turbine (1); S2: associating a predefined interval of accelerations with each maximum acceleration; S3: determining the number of occurrences of each interval of accelerations over the N time intervals; S4: deducing therefrom a mode for the N time intervals; S5: repeating steps S1 to S4 multiple times so as to obtain multiple modes; S6: comparing the modes obtained in this manner and deducing therefrom a change in the clearance (7).

### FIELD OF THE INVENTION

The invention relates to the use and maintenance of wind farms, and particularly that of detecting a failure of the mechanical connection between the tower and the foundation of a terrestrial wind turbine.

### TECHNICAL BACKGROUND

A terrestrial wind turbine comprises, in a manner known per se, a toward, blades, a nacelle fastened to the tower and on which the blades are mounted in rotation, and means for converting the mechanical energy of the blades into electrical energy. The tower of the terrestrial wind turbine rests on a bed to which it is linked by means of the foundations. During the use of the wind turbine, the entire structure is subjected to very high winds which engage the blades. Over time, the pressure exerted by the wind on the blades while actuating them is transmitted to the entire wind turbine and stresses in fatigue the embedding link between the tower of the wind turbine and its foundation. This repeated stressing causes weakening of the embedding link and therefore the appearance of a clearance, with consequences for the safety of the installation.

Currently, the monitoring of this clearance is carried out by means of movement sensors fastened to the foot of the wind turbine and configured to measure the movement of the wind turbine relative to the foundations in two directions comprised in the horizontal plane. It will be noted, however, that these sensors are not originally present on the wind turbine; it is therefore the responsibility of the operator to install this instrumentation.

### SUMMARY OF THE INVENTION

One objective of the invention is therefore to propose a new method allowing monitoring in a simple and robust manner the evolution of the clearance between a wind turbine and its foundations, which can further be implemented without necessary requiring specific instrumentation.

To this end, the invention proposes a method of monitoring clearance between a tower and foundations of a wind turbine comprising the following steps:

S1: acquiring, for N predetermined time intervals, N maximum accelerations of the tower of the wind turbine,

S2: for each maximum acceleration, associating a predefined acceleration interval, wherein each acceleration interval comprises a minimum acceleration value and a maximum acceleration value, the maximum acceleration being comprised between the minimum value and the maximum value of the associated acceleration interval,

S3: determining the number of occurrences of each acceleration interval over the N time intervals,

S4: deducing a mode for the N time intervals, a mode corresponding to the value of the acceleration interval for which the number of occurrences is greatest over the N time intervals,

S5: repeating steps S1 to S4 several times so as to obtain several modes,

S6: comparing the modes thus obtained and deducing them from an evolution of the clearance.

Certain preferred but not limiting features of the method for monitoring clearance between a tower and foundations of a wind turbine described above are the following, taken individually or in combination:
comparison step S6 comprises the following sub-steps:
   S61: defining, for each mode obtained in steps S4, a point the coordinates of which have as an abscissa a date associated with the time intervals in which said mode was determined as an abscissa, and as an ordinate a value of the mode,
   S62: determining a best-fit line from the points thus defined,
   S63: determining a slope of the best-fit line and
   S64: comparing the slope to a predetermined threshold.
the monitoring method further comprises, following the comparison step S6, a step of generating an alarm when the evolution of the clearance exceeds a predetermined threshold.
the accelerations are acquired at the nacelle of the wind turbine. And/or
the value of the acceleration interval comprising the minimum value of this acceleration interval, the maximum value of this acceleration interval or an average of the minimum value and of the maximum value.

According to a second aspect, the invention also proposes a computer program comprising instructions suited to the implementation of each of the steps of the method of monitoring clearance between a tower and foundations of a wind turbine described above when said program is executed on a computer.

According to a third aspect, the invention proposes a device for estimating a clearance between a tower and foundations of a wind turbine, comprising:
at least one accelerometer designed to acquire a maximum acceleration of the tower of the wind turbine during a measurement time interval;
at least one clock collaborating with the accelerometer so as to trigger the start and the end of the measurement time interval; and
a dynamic analysis tool configured to monitor the clearance in conformity with a method of monitoring clearance between a tower and foundations of a wind turbine as described above.

In one embodiment, the wind turbine further comprises a nacelle, the accelerometer being mounted in said nacelle.

### BRIEF DESCRIPTION OF THE DRAWINGS

Other features, goals and advantages of the present invention will appear more clearly upon reading the detailed description that follows, and with reference to the appended drawings given by way of non-limiting examples and in which:

FIG. 1 illustrates schematically an exemplary embodiment of a wind turbine,

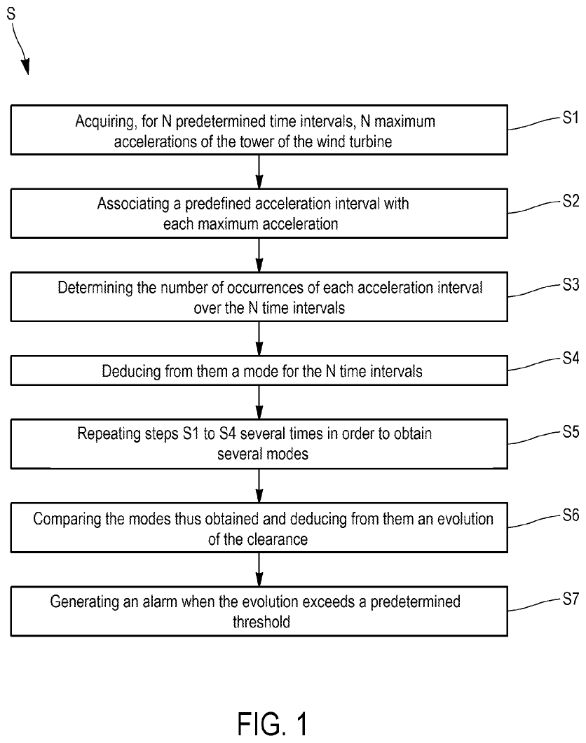

FIG. 2 is a flowchart showing the steps of an example of a method for monitoring clearance between a tower and foundations of a wind turbine conforming to the invention.

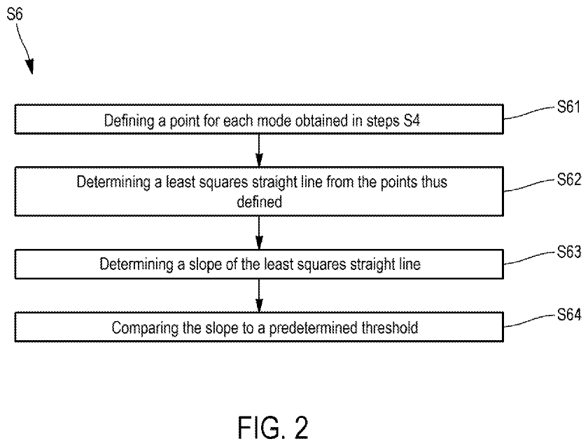

FIG. 3 is a flowchart showing sub-steps of the example of a method for monitoring clearance between a tower and foundations of a wind turbine of FIG. 2.

### DETAILED DESCRIPTION OF AN EMBODIMENT

Hereafter, a method for monitoring clearance 7 between a tower 2 and foundations of a wind turbine 1, particularly a terrestrial wind turbine 1, will be described.

Here the wind turbine 1 comprises, in a manner known per se, a tower 2, blades, a nacelle 4 fastened to the tower 2 and to which the blades are mounted in rotation, and means for converting the mechanical energy 3 of the blades into electrical energy. The tower 2 of the terrestrial wind turbine 1 rests on a bed to which it is linked by means of the foundations.

The wind turbine 1 further includes an accelerometer 10 which is mounted in the nacelle 4. This accelerometer 10 is customarily used to monitor the vibrations of the nacelle 4 and delivers and records for this purpose information on the acceleration of the nacelle 4 over predetermined time intervals. This information is stored in a database and includes a set of statistical data, for given interval of time (with a duration on the order of a few minutes) and comprising for example: average acceleration and its standard deviation over the given interval of time, maximum and minimum accelerations over the given interval of time, etc.

The invention proposes to benefit from this accelerometer 10 and the data that it already supplies and records, in order to additionally monitor the clearance 7 of the wind turbine 1 and the state of health of the embedding link between the wind turbine 1 and its foundation.

Of course, the invention applies by analogy to any other accelerometer 10, and particularly by applying another accelerometer 10 to the wind turbine 1 or by using another accelerometer 10 already present on the wind turbine 1. This other accelerometer 10 can of course be mounted or on the nacelle 4, but also in or on the tower 2 of the wind turbine 1 or at the embedding link.

In order to monitor clearance 7 between a tower 2 and foundations of a wind turbine 1, the method comprises the following steps:

S1: acquiring, for N predetermined time intervals, N maximum accelerations of the tower 2 of the wind turbine 1,

S2: for each maximum acceleration, associating a predefined acceleration interval, where each acceleration interval comprises a minimum acceleration value and a maximum acceleration value, the maximum acceleration being comprised between the minimum value and the maximum value,

S3: determining the number of occurrences of each acceleration interval over the N time intervals,

S4: deducing from them a mode for the N time intervals, corresponding to a value of the acceleration interval for which the number of occurrences is greatest over the N time intervals,

S5: repeating steps S1 to S4 several times so as to obtain several modes,

S6: comparing the modes thus obtained and deducing from them an evolution of the clearance.

What is involved, then, it to create a probability density function of the maximum acceleration of the wind turbine 1, preferably along the axis which faces the wind direction (this being possible when the accelerometer 10 is mounted on or in the nacelle 4). This probability density function then characterizes the statistical distribution of the maximum accelerations measured by the accelerometer 10 over a given period of time. It is then the evolution over time of the modes that allows the evolution of clearance to be monitored.

In fact, the maximum of the maximum acceleration of the nacelle 4 is affected by the presence of a clearance 7 at the foundation, which modifies the assembly formed by the foundation and the tower 2 in terms of the horizontal displacement of the end of the tower 2 and of the stiffness of the tower 2. In fact, to reach its maximum horizontal displacement, the free end of the wind turbine 1 will require additional time due to the fact of the increase in the distance to be traveled for a fixed speed (imposed by the wind speed). Hence, the acceleration being a ratio of a speed and a time, it will decrease with the creation of a clearance 7 at the foot of the wind turbine 1, at the embedding link. It is therefore this phenomenon that the invention proposes to monitor by means of the steps mentioned above.

Preferably, steps S1 to S4 are repeated during a fixed time interval I, which is a multiple of a year, in order to take seasonal effects into account. In other words, it is preferable to have a history of acceleration data with a duration greater than or equal to this fixed time interval I.

To this end, during the first step S1, for N predetermined time intervals, N maximum accelerations of the tower 2 of the wind turbine 1 are acquired. This acquisition can in particular be performed within the scope of the customary acquisitions of the accelerometer 10, by retrieving the maximum accelerations recorded over N time intervals.

During the second step S2, a predefined acceleration interval is associated with each of the N maximum accelerations thus acquired. The acceleration intervals each comprise a minimum acceleration value and a maximum acceleration value, and the maximum acceleration value is associated with the acceleration interval for which the minimum acceleration value is less and the maximum acceleration value is greater.

Preferably, the acceleration intervals are disjoint and cover together all possible maximum acceleration values. Furthermore, the length of the acceleration intervals is identical. For example, for an acceleration interval length equal to 1 mm/s², the acceleration intervals can be defined as follows: [0; 1] mm/s²; ]1; 2] mm/s²;]2; 3] mm/s²; [. . .]; ]aₘₐₓ₊₁; aₘₐₓ].

During step S3, the number of occurrences of each acceleration is determined, for the N time intervals. For example, the probability density of the acceleration intervals associated with the N maximum accelerations acquired during the N time intervals can be traced.

The mode for these N time intervals is then deduced, this mode corresponding to the value of the acceleration interval for which the number of occurrences is greatest over the N time intervals. The acceleration interval comprising an infinity of acceleration values, it is possible for example to select the minimum value, the maximum value or the average of the acceleration interval of which the number is greatest as the mode value. This, however, is not limiting; it is possible to select any other value of the acceleration interval in question.

Steps S1 to S4 are then repeated over N additional time intervals, until the date of the end of the fixed time interval I (step S5). Thus p modes are obtained during this fixed time interval I. Preferably, steps S1 to S4 are repeated at a given fixed frequency. The number of modes obtained can be adjusted by modifying the given fixed frequency, the number of time intervals and the duration of said time intervals.

During step S6, the p modes thus obtained are then compared in order to deduce from them the evolution of the clearance.

For that purpose, it is for example possible to define, for each of the p modes obtained, a point, the coordinates of which have as their abscissa a date associated with the time intervals over which said mode has been determined as the abscissa and a value of the mode as the ordinate (step S61).

Then a best-fit line according to a method of least squares is determined (step S62) from the points thus defined as well as the slope of this best-fit line (step S63). Finally, the slope is compared to a predetermined threshold (step S64).

If the slope reaches or exceeds the predetermined threshold, it is considered that the clearance 7 of the wind turbine 1 is high. If necessary, an alarm can be triggered (step S7).

In order to implement the method S for monitoring clearance 7 between the tower 2 and the foundations 6 of the wind turbine, the device comprises, in addition to the accelerometer 10, which can be housed in the nacelle 4 of the wind turbine or in any other portion of it:
at least one clock 11 collaborating with the accelerometer so as to trigger the start and the end of the measurement time interval N; and
a dynamic analysis tool 12 configured to monitor the clearance 7 in conformity with said method S.

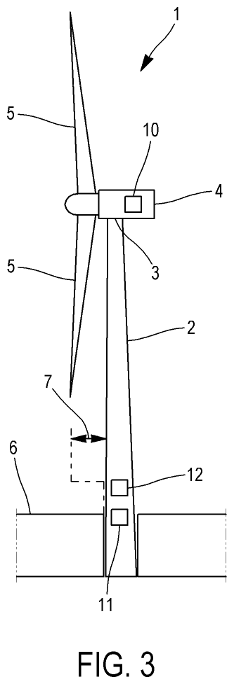

The clock 11 and the dynamic analysis tool 12 can both be housed in the wind turbine 1, as illustrated in FIG. 3. As a variant, the clock 11 and/or the dynamic analysis tool 12 can be placed at a distance from the wind turbine, in a dedicated enclosure, and connected by wired or wireless link to the wind turbine 1.

1. A monitoring method comprising the following steps:
S1: acquiring, for N predetermined time intervals, N maximal accelerations of a tower of a wind turbine;
S2: for each maximal acceleration, associating a predefined acceleration interval, wherein each predefined acceleration interval comprises a minimum acceleration value and a maximum acceleration value, the maximal acceleration being comprised between the minimum value and the maximum value of the associated predefined acceleration interval;
S3: determining a number of occurrences of each acceleration interval over the N predetermined time intervals;
S4: deducing a mode for the N predetermined time intervals, the mode corresponding to a value of the predefined acceleration interval for which the number of occurrences is greatest over the N time intervals; and
S5: repeating steps S1 to S4 several times so as to obtain several modes,
S6: comparing the modes thus obtained and deducing therefrom an evolution of a clearance between the tower and foundations of the wind turbine.

2. The monitoring method of claim 1, wherein the comparison step S6 comprises the following sub-steps:
S61: defining, for each mode obtained in step S4, a point having an abscissa and an ordinate, wherein the abscissa corresponds to the predefined time intervals in which the mode was deduced and the ordinate corresponds to a value of the mode;
S62: determining a best-fit line from the points thus defined;
S63: determining a slope of the best-fit line; and
S64: comparing the slope of the best fit line to a predetermined threshold.

3. The monitoring method of claim 2, further comprising, following the comparing step S6, a step of generating an alarm when the evolution of the clearance exceeds the predetermined threshold.

4. The monitoring method of claim 1, wherein the N maximum accelerations are acquired at a nacelle of the wind turbine.

5. The monitoring method of claim 1, wherein the maximal acceleration comprises the minimum value of the predetermined acceleration interval, the maximum value of the predetermined acceleration interval or an average of the minimum value and of the maximum value of the predetermined acceleration interval.

6. A computer program comprising instructions for the implementation of each of the steps of the monitoring method of claim 1 when said program is executed on a computer.

7. A device for estimating a clearance between a tower and foundations of a wind turbine comprising:
at least one accelerometer designed to acquire a maximal acceleration of the tower of the wind turbine during a measurement time interval N;
at least one clock collaborating with the accelerometer so as to trigger a start and a end of the measurement time interval N; and
a dynamic analysis tool configured to monitor the clearance in accordance with a monitoring method according to claim 1.

8. The device of claim 7, wherein the wind turbine further comprises a nacelle, the accelerometer being mounted in said nacelle.
